(19) United States
(12) Patent Application Publication
(10) Pub. No.: US 2005/0132637 A1
(43) Pub. Date: Jun. 23, 2005

(54) Pest control device

(76) Inventor: Joseph M. Deakins, Johnson City, TN (US)

Correspondence Address: Donald W. Spurrell, P.O. Box 970, Johnson City, TN, 37605, US

(21) Appl. No.: 10/738,500

(22) Filed: Dec. 17, 2003

(51) Int. Cl. A01M 25/00

(52) U.S. Cl. 43/131

(57) ABSTRACT

A poison bait device having a poison bait container which, in operation, is accessible to rodents such as rats and mice but which is inaccessible to other creatures including humans, birds, dogs, cats and the like, wherein the only access to the bait well is thru a relatively small diameter tube having a tortuous path such as curves thru which rats and mice must slither, and wherein the entrance(s) to said tube is generally planar and adapted for sufficiently close to the ground and substantially parallel to the ground plane whereby children, pets and birds cannot reach the bait.

### BACKGROUND OF THE INVENTION

1. Field

The present device concerns a unique structure designed to contain poisons for the eradication of rats and other rodents, particularly outside of homes or other buildings. The device was developed to provide a safe, easy to use, weather resistant unit for containing various, readily available commercial poisons such as DCON and the like.

2. Prior Art

Heretofore the use of rat poisons and the like, typically in bait form and contained in a box or the like having doors or other openings, has necessitated extensive precautionary measures for preventing accidental poisoning of domestic animals, infants, pets, and birds particularly where the bait is placed within the home. These measures are seldom effective however in that the poison bait must be accessible to the target rodents which, of course makes the bait accessible to many other creatures. Also, death of rodents within a home usually results in unacceptable stench which is very difficult to eradicate.

Various poison bait station devices are available for outside the home use for controlling the rodent numbers to a level which can be managed by plugging up all of the holes in flooring, walls, roof structures and the like where rodents typically find entrance to the building. These devices however, again are indiscriminate in what animal or bird they kill.

### SUMMARY OF THE INVENTION

The present invention provides a solution to all of the aforesaid problems by providing a poison bait device having a poison bait container which, in operation, is accessible to rodents such as rats and mice but which is inaccessible to other creatures including humans, birds, dogs, cats and the like, wherein the only access to the bait well is thru a relatively small diameter tube having a tortuous path thru which rats and mice must slither, and wherein the entrance to said tube is generally planar and adapted for positioning close to the ground and substantially parallel to the ground plane.

### BRIEF DESCRIPTION OF THE DRAWINGS

The invention and its objects will be understood further from the following drawings and description, wherein:

FIG. 1 is a cross-sectional side view of a dual access embodiment of the present device;

FIG. 2 is an end view of the device with portions broken away for clarity and taken along line 2-2 in FIG. 1;

FIG. 3 is a cross-sectional view taken along line 3-3 in FIG. 1 and showing a variation of the housing having a rodent scent container section;

FIG. 4 is a top down view of the device taken along line 4-4 in FIG. 1; and

FIG. 5 is a side view of a variation in configuration of the present device.

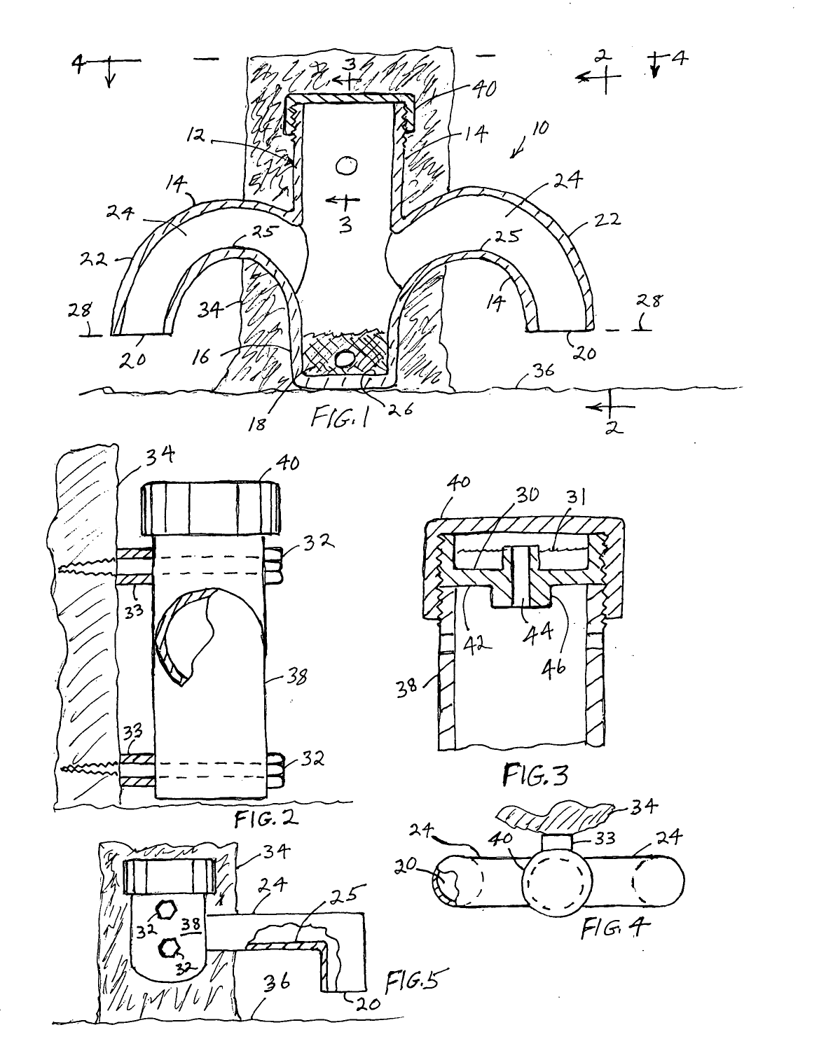

### DETAILED DESCRIPTION

The present device 10 in its more preferred embodiments is described below, with particular reference to the claims and drawings herein, wherein the structures are not drawn to scale or in actual proportions to each other and wherein certain dimensions are enlarged for clarity. The device can be constructed of any strong, durable, weatherable material including fabricated metal or wood, or molded plastic or ceramic, but preferably is comprised of adhesively connected PVC plumbing sections which, of course are readily available and provide the desired tubular contours.

The device comprises a bait containment housing 12 formed by wall means 14 to provide (1) a well portion 16 for containing poisoned bait 18, (2) a rodent access opening 20 laterally displaced from said well portion, and (3) at least one tube portion 22 interconnecting the well portion and opening for allowing rodents to enter the housing and reach the bait and then exit the housing. Each tube portion has at least one run section generally designated 24, the inner bottom surface 25 of which is preferably located from about 1.5 to about 5.0 inches above the bottom 26 of the well portion. Each opening 20 lies in a generally horizontal plane 28 and the housing is configured and dimensioned such that the bottom 26 of the well portion is from about 1.0 to about 3.0 inches below the plane 28 of the opening 20.

Attachment means 32 is provided on the housing for positioning and securing the housing to a support 34 at a position relative to the ground whereby the plane 28 of the opening 20 is from about 1.0 to about 3.0 inches above the ground. Means 32 can be nails, lag screws, or the like and bushings 33 are preferably provided to space body portion 38 from a tree 34 or other support such as a fence post or building skirting such that cap 40 can be readily removed to refill the bait well or a scent chamber such as 30.

In this regard the scent may be liquid 31 or solid and is used, if desired, as an additional attraction to the bait. The main body portion 38 of the housing is provided at its top with a screw on cap 40 which may be provided with a safety or tamper proof locking mechanism (not shown). The scent chamber 31 containing, e.g., pheromones, is conveniently provided by a screw-in plate 42 having a scent emitting aperture 44 and a hex nut or the like portion 46 to which a wrench may be applied to tighten the plate up into the cap 40.

The configuration and dimensions of the device can be greatly varied, however, it is most preferred that openings 20 and tube portions 22 be no more than about 2.0 inches in inside diameter. The well portion 16 preferably should be sufficiently deep as to make it somewhat difficult for the rodent to pull the bait out of the device. Also the opening(s) 20 best serve the purpose by being less than about 2.0 inches from the ground where, e.g., a childs or pets arm could not get up in thru the opening and around the bend in tube portion 22.

The invention has been described in detail with particular reference to preferred embodiments thereof, but it will be understood that variations and modifications will be effected with the spirit and scope of the invention.

1. A poison bait device having a poison bait container which, in operation, is accessible to rodents such as rats and mice but which is inaccessible to other creatures including humans, birds, dogs, cats and the like, said device comprising a bait containment housing formed by wall means to provide (1) a well portion for containing poisoned bait, (2) a rodent access opening laterally displaced from said well portion, and (3) at least one open ended tube portion interconnecting said well portion and said rodent access opening for allowing rodents to enter the housing and reach the bait and then exit the housing, wherein each tube portion has at least one run section having an inner bottom surface which is located above the bottom of said well portion, wherein each rodent access opening lies in a generally horizontal plane, wherein the housing is configured and dimensioned such that when said device is affixed to a structure and is in its operational posture, said rodent access opening is oriented generally parallel to and close to the ground, and wherein attachment means is provided on the housing for positioning and securing the housing to a support at a desired elevation above the ground.

2. The device of claim 1 wherein each rodent access opening lies in a generally horizontal plane and the housing is configured and dimensioned such that the bottom of the well portion is from about 1.0 to about 3.0 inches below the plane of said rodent access opening.

3. The device of claim 1 wherein said attachment means is provided on the housing for positioning and securing the housing to a support at a position relative to the ground whereby the plane of said rodent access opening is from about 1.0 to about 3.0 inches above the ground.

4. The device of claim 1 wherein a cap means is provided on said housing for providing access to said well portion for bait resupply.

5. The device of claim 1 wherein a containment means is provided on the device for containing a supplemental rodent scent material and dispensing it within the device.

6. The device of claim 1 wherein said housing comprises adhesively connected tubular PVC plumbing sections.

7. The device of claim 1 wherein said housing is configured whereby said well portion resides in a central tubular section of said housing, and wherein a said tube portion extends outwardly from each of opposite sides of said central tubular section.

8. The device of claim 6 wherein said housing is configured whereby said well portion resides in a central generally upright tubular section of said housing, and wherein a said tube portion extends outwardly from each of opposite sides of said central tubular section.

9. The device of claim 8 wherein, in the operation of said device, the inner bottom surface of each said tube portion is located from about 1.5 to about 5.0 inches above the bottom of said well portion, and wherein each rodent access opening lies in a generally horizontal plane and the housing is configured and dimensioned such that the bottom of said well portion is from about 1.0 to about 3.0 inches below the plane of said opening.
